(19) United States
(12) Patent Application Publication
(10) Pub. No.: US 2025/0307018 A1
(43) Pub. Date: Oct. 2, 2025

(54) MAPPING THREADS TO CORES FOR TELECOMS PERFORMANCE

(71) Applicant: MICROSOFT TECHNOLOGY LICENSING, LLC, Redmond, WA (US)

(72) Inventor: Zhige YU, London (GB)

(21) Appl. No.: 18/622,736

(22) Filed: Mar. 29, 2024

(51) Int. Cl. G06F 9/50

(52) U.S. Cl. CPC G06F 9/505

(57) ABSTRACT

A node of a telecommunications network has a plurality of cores, a file system, and a container for executing data plane functionality of the telecommunications network. A memory of the node stores instructions that, when executed by one of the cores, perform a method for reading a record in the file system. The record identifies which of the cores have been allocated to the container. For each of a plurality of threads of the container, a mapping is recorded between the thread and one of the cores. Each thread is executed on one of the cores according to the mapping.

### BACKGROUND

Cloud technology serves as a potential solution to meet the demands of application providers seeking to outsource the management of hardware resources such as telecommunications hardware resources. However, considering the resources available through cloud services are used by multiple parties, cloud technology is typically not sufficient to meet the significant security and/or reliability requirements of handling application requests such as telephony application requests. Therefore, there is a need for telephony applications, including 5G telephony applications, deployed using cloud technology which are able to provide high levels of reliability and/or security.

Where a telephony service or application is deployed in the cloud the functionality of the service is typically provided using a plurality of clusters, each cluster comprising one or more compute nodes where functionality providing at least part of the service is installed. Within a cluster are individual nodes and where each node may have more than one central processing unit (CPU) each CPU having one or more cores. Managing allocation of work between clusters, nodes, CPUs and cores is an ongoing challenge.

The examples described below are not limited to implementations which solve any or all of the disadvantages of known telecommunications networks deployed using cloud technology.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

Controlling how threads of a telecommunications network data plane container are allocated to cores of a node facilitates telecommunications grade performance.

A node of a telecommunications network has a plurality of cores, a file system, and a container for executing data plane functionality of the telecommunications network. A memory of the node stores instructions that, when executed by one of the cores, perform a method for reading a record in the file system. The record identifies which of the cores have been allocated to the container. For each of a plurality of threads of the container, a mapping is recorded between the thread and one of the cores. Each thread is executed on one of the cores according to the mapping.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a telecommunications network and with an exploded view of a node of the telecommunications network;

FIG. 2 is a schematic diagram of a node of a telecommunications network, such as that of FIG. 1;

FIG. 3 is a flow diagram of a method performed by an agent and by a group of containers on a node;

FIG. 4 illustrates an exemplary computing-based device in which a node of a telecommunications network is implemented in some examples.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

The inventors have recognized that performance problems are experienced where an agent of an orchestrator does not inform a container which CPU cores of a host node have been allocated to the container. Where the container is executing an application for a telephony grade service this is a significant problem as the application does not know which CPU cores have been allocated and so cannot allocate threads in an informed manner. The application is forced to operate in a “blind” manner simply operating threads without information about which CPU cores the threads are allocated to. In some cases the threads are allocated to CPU cores already being used by other processes and with little capacity. Where the application is part of a telephony grade service, this can lead to delays in establishing calls or inability to establish a call which is not acceptable such as in the case of calls to the emergency services. There is also less predictable performance. The end user can experience noise on the call or inability to make a call. In extreme cases of overload of a CPU core, calls may be dropped. An additional problem is that if threads aren't allocated to specific cores, they can be moved between cores, causing lots of overhead (context switching). The inventors have recognized that many existing orchestrators do not enable an application to run a single specific thread on a single specific core from the set of cores assigned to the container owning the thread.

The inventors have developed a way to enable an agent to expose a record in a file system of the host node to a container and have the container make use of it. The record indicating which CPU cores have been allocated to a specified container. Using this record in the file system a mapping between cores and threads of a container may be formed and used to control which threads are executed on which cores in order to facilitate performance. In this way performance of an application, such as a data plane application of a telephony grade service is facilitated.

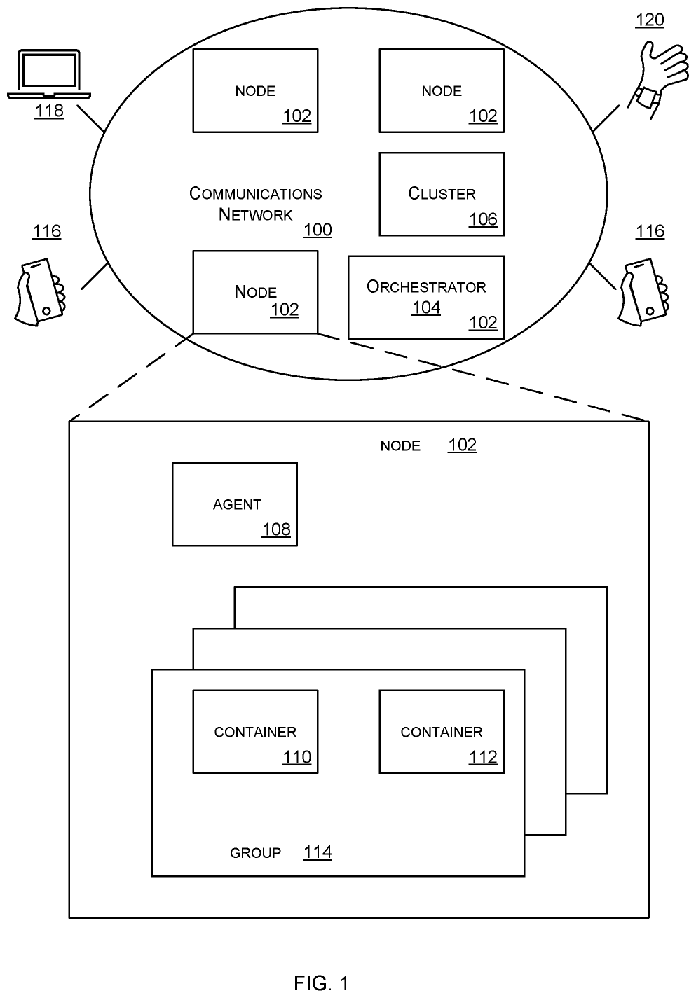

FIG. 1 is a schematic diagram of a telecommunications network 100 and with an exploded view of a node 102 of the telecommunications network. The telecommunications network 100 enables calls to take place between end user communication devices such as smart phone 116, desktop computer 118, smart watch 120, or other communication devices. The telecommunications network 100 comprises a plurality of nodes 102 interconnected by links. Each node is either a physical computer or a virtual machine on a physical computer. The telecommunications network 100 has clusters of nodes 102 such as cluster 106. A cluster 106 may be a cluster of compute nodes in a data centre.

FIG. 1 shows an exploded view of one of the nodes 102 comprising an agent 108 and a plurality of groups 114. FIG. 1 shows three groups 114 in one node 102 although in practice there may be many more groups in the node.

The groups are smallest deployable units of a telephony service. Each group 114 is a group of two or more containers 110, 112 where a container is a package of software code for running on a host operating system in a stand alone manner (without the need to obtain libraries, configuration files or other things the software needs to run from other sources). At least one of the containers in each group contains software of a data plane application of a telephony service. A data plane application of a telephony service is software that processes packets comprising media (such as audio and/or video) of a call. The term “workload container” is used herein to refer to a container that processes media packets for a call. FIG. 1 shows two containers 110, 112 in one group 114 although in practice there may be more containers in a group.

The agent 108 is an agent of an orchestrator 104. An orchestrator is computer implemented functionality for automating life cycle management of containers of containerized applications. An orchestrator is able to trigger instantiation of containers, trigger termination of containers, and facilitate efficient interaction between containers. In an example the orchestrator 104 is Kubernetes. However, it is not essential to orchestrate the telecommunications service using Kubernetes (trade mark) as any orchestrator may be used including but not limited to: Docker Swarm (trade mark), Nomad (trade mark), Redhat OpenShift (trade mark), Amazon Elastic Container Service (trade mark).

In a non-limiting example the groups 114 are Kubernetes (trade mark) pods and the agent 108 is a Kubelet where the service is orchestrated using Kubernetes (trade mark).

In order to enable a call between two or more of the end user communication devices such as smart phone 116 and smart watch 120, containerized applications in the groups 114 are deployed in the communications network using well known technology. There may be hundreds or thousands of units 114 in a cluster 106.

When the agent 108 triggers instantiation of a workload container in a group 114 on the node 102, the agent 108 allocates one or more cores of a CPU of the node 102 to the workload container. However, the workload container may be unaware of the allocation. Thus an application executing in the workload container is also unaware of the allocation making it difficult for the application to manage performance. To address this the inventors have developed a way of using a file system of the node 102.

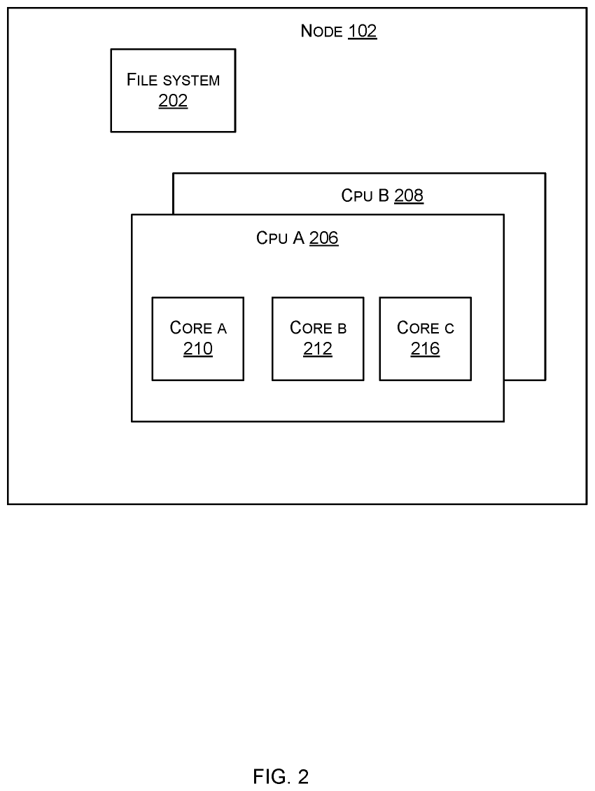

FIG. 2 is a schematic diagram of a node 102 of a telecommunications network, such as that of FIG. 1. The node 102 comprises a file system 202 stored in a memory of the node 102 and accessible to an operating system of a node 102. The node 102 has a plurality of CPUs, CPU A 206, CPU B 208. Each CPU comprises two or more cores; in an example there may be around 16 cores per CPU. FIG. 2 shows three cores 210, 212, 216 in CPU A 206. This is an example only and there may be more cores in practice. Where the node 102 is a virtual machine, the CPUs are on a host machine of the virtual machine.

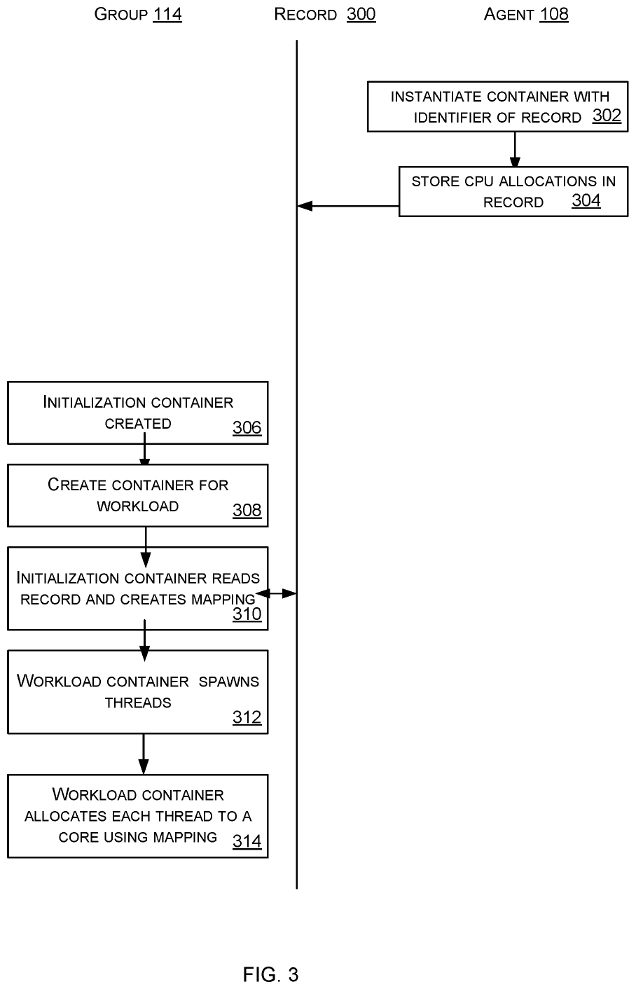

FIG. 3 is a flow diagram of a method performed by an agent 108 and of a method performed by a group 114 of containers on a node 102. The node 102 has a record 300 in a file system 202 of the node 102. Relative vertical position of the boxes in FIG. 3 represents chronological order.

An agent 108 instantiates 302 a container on the node 102 by sending a link to source code, libraries, and other dependencies of the container to the node 102 (so the container can be copied to the node) and by allocating resources of the node 102 for use by the container. The agent 108 queries an operating system of the node 102 to find what resources the node 102 has, such as what CPUs there are and what cores the CPUs have. The agent uses rules or other criteria to allocate resources of the node 102 to the container, such as by selecting one of the cores on one or more of the CPUs. When the agent triggers instantiation of the container it does not send details of what cores were allocated to the container. The agent 108 stores 304 the CPU allocations in the record 300 in the file system of the node 102. The agent 108 may create a table in the record 300 where the table has a row for each container indicating a name of the container and a list of cores allocated to the container. The name of the container is known to the agent since the agent triggered instantiation of the container. The container being instantiated in the group 114 may be a workload container that is for processing data plane packets of a telecommunications network service.

In response to the agent 108 having triggered instantiation of a workload container at operation 302, the group 114 instantiates an initialization container 306 within the group 114 on the node 102. The group 114 also creates 308 the workload container 308.

The initialization container has an identifier of the record 300 in the file system. The initialization container reads 310 the record and so finds out which cores have been allocated to the workload container by the agent 108. The initialization container creates a mapping between a specified number of anticipated threads of the workload container and the cores which have been allocated to the workload container by the agent 108. The mapping is stored in the file system. The workload container knows the location of the mapping in the file system.

The workload container spawns 312 (i.e. creates) a plurality of threads, such as a specified fixed number of threads. The workload container allocates 314 each thread to a core using the mapping and executes the threads. This enables context switching to be avoided since threads do not jump between cores. Context switching is where a thread moves between cores and a context of the thread has to be copied from the core the thread originates from to the core the thread is switched to. Context switching is time consuming and leads to unacceptable latency in the case of telephony grade applications. Each thread my be allocated an entire core to give efficiency and predictability.

In the example of FIG. 3 the group 114 of containers implements functionality of a telecommunications service such as a 5G telecommunications network service. During instantiation of the group of containers, an initialization container and a workload container are instantiated. The workload container is able to process media packets of a call for example. Having the initialization container provides a way to enable threads to be allocated between cores in a way to facilitate performance of the telecommunications service. Using the initialization container, a record in a file system of the host computing node is read. Using the file system is efficient and enables transfer of information between the agent and the initialization container which otherwise is difficult to achieve. The record identifies a plurality of cores of the host computing node which have been allocated to the workload container by the agent. Using the initialization container, for each of a plurality of threads, a mapping is recorded between the thread and one of the cores. The mapping may be arranged to facilitate performance of the telecommunications service, such as by having only one thread per core or in other ways. Using the workload container, the plurality of threads are initialized for executing an application of the workload container and the threads are executed on the cores according to the mapping. Thus performance of the application in the workload container is controlled through controlling what threads execute on what cores.

Enabling a container to access file system of a host of the container to find what cores of the host have been allocated to the container enables the container to operate in an unconventional manner to achieve predictable and efficient performance of the container such as for a telephony grade application.

Enabling a container to access a file system of a host of the container to find what resources of the host have been allocated to the container improves the functioning of the underlying communications network node.

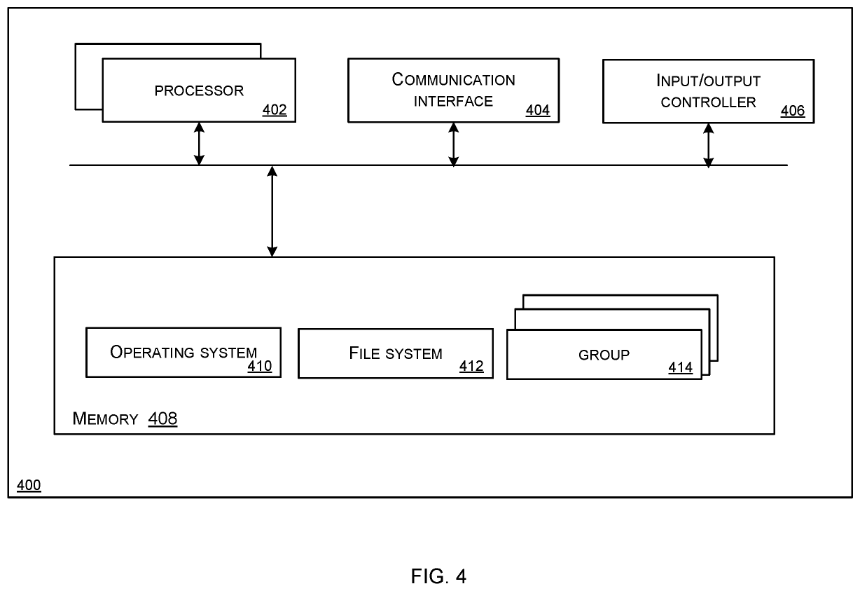

FIG. 4 illustrates various components of an exemplary computing-based device 400 which are implemented as any form of a computing and/or electronic device, and in which examples of a communications network node are implemented.

Computing-based device 400 comprises a plurality of processors 402 which are microprocessors, controllers or any other suitable type of processors for processing computer executable instructions to control the operation of the device in order to execute a telephony grade application. In an example the processors comprise a plurality of CPUs, each CPU having a plurality of processing cores. In some examples, for example where a system on a chip architecture is used, the processors 402 include one or more fixed function blocks (also referred to as accelerators) which implement a part of the method of FIG. 3 in hardware (rather than software or firmware). Platform software comprising an operating system 410 or any other suitable platform software is provided at the computing-based device. The computing-based device 400 has a plurality of groups 414 each group being a plurality of containers of a containerized telephony grade application such as a 5G telecoms service. The computing-based device 400 has a memory 408 storing a file system 412 accessible to the groups 414.

The computer executable instructions are provided using any computer-readable media that is accessible by computing based device 400. Computer-readable media includes, for example, computer storage media such as memory 408 and communications media. Computer storage media, such as memory 408, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, optical storage, magnetic storage, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 408) is shown within the computing-based device 400 it will be appreciated that the storage is, in some examples, distributed or located remotely and accessed via a network or other communication link (e.g. using communication interface 404).

The computing-based device 400 also comprises an input/output controller 406 arranged to output display information to an optional display device which may be separate from or integral to the computing-based device 400. The display information may provide a graphical user interface. The input/output controller 406 is optionally arranged to receive and process input from one or more devices, such as a user input device (e.g. a mouse, keyboard, camera, microphone or other sensor).

The computing-based device 400 is able to communicate with other nodes of a telecommunications network via communication interface 404.

Alternatively or in addition to the other examples described herein, examples include any combination of the following clauses:

Clause A. A method performed by a group of containers on a host computing node, the group of containers implementing functionality of a telecommunications service, the method comprising:
during instantiation of the group of containers, instantiating an initialization container and a workload container;
using the initialization container, reading a record in a file system of the host computing node, the record identifying a plurality of cores of the host computing node which have been allocated to the workload container;
using the initialization container, for each of a plurality of threads, recording a mapping between the thread and one of the cores;
using the workload container, initializing the plurality of threads for executing an application of the workload container;
using the workload container, executing each thread on one of the cores according to the mapping.

Clause B. The method of clause A wherein the initialization container comprises instructions for reading the record in the file system.

Clause C. The method of any preceding clause comprising recording the mapping in the file system of the host computing node.

Clause D. The method of any preceding clause wherein the plurality of cores are in the same central processing unit (CPU) of the host computing node.

Clause E. The method of any preceding clause wherein each thread is allocated to a different one of the cores.

Clause F. The method of any preceding clause wherein the group of containers is a Kubernetes pod.

Clause G. The method of any preceding clause wherein the workload container contains a data plane application of a telecommunications network service.

Clause H. The method of any preceding clause comprising using an agent at the host computing node to allocate the cores to the containers and to update the record in the file system with, for each container, a name of the container and identifier(s) of one or more of the cores allocated to the container.

Clause I. The method of any preceding clause comprising using an agent at the host computing node to instantiate the initialization container such that it has an identifier of the record in the file system.

Clause J. A node of a telecommunications network comprising:
a plurality of cores;
a file system;
a container for executing data plane functionality of the telecommunications network;
a memory storing instructions that, when executed by one of the cores, perform a method comprising:
reading a record in the file system, the record identifying which of the cores have been allocated to the container;
for each of a plurality of threads of the container, recording a mapping between the thread and one of the cores;
executing each thread on one of the cores according to the mapping.

Clause K. The apparatus of clause I comprising an initialization container comprising instructions for reading the record in the file system.

Clause L. The apparatus of clause I or clause J wherein the file system comprises the mapping.

Clause M. The apparatus of any of clauses I to K wherein the plurality of cores are in a same central processing unit (CPU) of the node.

Clause N. The apparatus of any of clauses I to L wherein each thread is allocated to a different one of the cores.

Clause O. The apparatus of any of clauses I to M comprising a Kubernetes pod containing the container.

Clause P The apparatus of any of clauses I to N comprising an agent of an orchestrator of the telecommunications network service.

Clause Q. The apparatus of clause O wherein the agent comprises instructions to allocate one or more of the cores to the container and to update the record in the file system with a name of the container and identifier(s) of one or more of the cores allocated to the container.

Clause R. The apparatus of clause O or clause P wherein the agent comprises instructions to instantiate the initialization container such that it has an identifier of the record in the file system.

Clause S. The apparatus of any of clauses O to Q wherein the agent is a Kubelet.

Clause T. A node of a telecommunications network comprising:
a plurality of cores;
a group of containers comprising at least an initialization container and a workload container;
a file system;
herein the initialization container comprises instructions to read a record a file system, the record identifying a plurality of the cores which have been allocated to the workload container;
wherein the workload container comprises instructions to execute a plurality of threads on specified ones of the plurality of cores allocated to the workload container, according to a mapping between threads and cores, the mapping created by the initialization container.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various examples have been described above with a certain degree of particularity, or with reference to one or more individual embodiments, those skilled in the art could make numerous alterations to the disclosed embodiments without departing from the scope of this specification.

What is claimed is:

1. A method performed by a group of containers on a host computing node, the group of containers implementing functionality of a telecommunications service, the method comprising:
during instantiation of the group of containers, instantiating an initialization container and a workload container;
using the initialization container, reading a record in a file system of the host computing node, the record identifying a plurality of cores of the host computing node which have been allocated to the workload container;
using the initialization container, for each of a plurality of threads, recording a mapping between the thread and one of the cores;
using the workload container, initializing the plurality of threads for executing an application of the workload container; and
using the workload container, executing each thread on one of the cores according to the mapping.

2. The method of claim 1, wherein the initialization container comprises instructions for reading the record in the file system.

3. The method of claim 1, further comprising recording the mapping in the file system of the host computing node.

4. The method of claim 1, wherein the plurality of cores are in the same central processing unit (CPU) of the host computing node.

5. The method of claim 1, wherein each thread is allocated to a different one of the cores.

6. The method of claim 1, wherein the group of containers is a Kubernetes pod.

7. The method of claim 1, wherein the workload container contains a data plane application of a telecommunications network service.

8. The method of claim 1, further comprising using an agent at the host computing node to allocate the cores to the containers and to update the record in the file system with, for each container, a name of the container and identifier(s) of one or more of the cores allocated to the container.

9. The method of claim 1, further comprising using an agent at the host computing node to instantiate the initialization container such that it has an identifier of the record in the file system.

10. A node of a telecommunications network, the node comprising:
a plurality of cores;
a file system;
a container for executing data plane functionality of the telecommunications network;
a memory storing instructions that, when executed by one of the cores, cause the node to perform operations comprising:
reading a record in the file system, the record identifying which of the cores have been allocated to the container;
for each of a plurality of threads of the container, recording a mapping between the thread and one of the cores; and
executing each thread on one of the cores according to the mapping.

11. The node of claim 10, further comprising an initialization container comprising instructions for reading the record in the file system.

12. The node of claim 10, wherein the file system comprises the mapping.

13. The node of claim 10, wherein the plurality of cores are in a same central processing unit (CPU) of the node.

14. The node of claim 10, wherein each thread is allocated to a different one of the cores.

15. The node of claim 10, further comprising a Kubernetes pod containing the container.

16. The node of claim 10, further comprising an agent of an orchestrator of the telecommunications network.

17. The node of claim 16, wherein the agent comprises instructions to allocate one or more of the cores to the container and to update the record in the file system with a name of the container and identifier(s) of one or more of the cores allocated to the container.

18. The node of claim 16, further comprising an initialization container comprising instructions for reading the record in the file system, wherein the agent comprises instructions to instantiate the initialization container such that it has an identifier of the record in the file system.

19. The node of claim 16, wherein the agent is a Kubelet.

20. A node of a telecommunications network, the node comprising:
a plurality of cores;
a group of containers comprising at least an initialization container and a workload container;
a file system;
the initialization container configured to read a record a file system, the record identifying a plurality of the cores which have been allocated to the workload container; and
the workload container configured to execute a plurality of threads on specified ones of the plurality of cores allocated to the workload container according to a mapping between threads and cores, the mapping created by the initialization container.
